(19) United States
(12) Patent Application Publication
(10) Pub. No.: US 2026/0177774 A1
(43) Pub. Date: Jun. 25, 2026

(54) MODULE PULLING CONTAINER

(71) Applicant: viaPhoton, Inc., Aurora, IL (US)

(72) Inventors: Keith Samuel MARANTO, Frankfort, IL (US); Walter Mark HENDRIX, Dallas, TX (US); Syed Babar ABBAS, Chicago, IL (US)

(21) Appl. No.: 19/278,364

(22) Filed: Jul. 23, 2025

Related U.S. Application Data
(63) Continuation-in-part of application No. 18/938,870, filed on Nov. 6, 2024.
(60) Provisional application No. 63/596,560, filed on Nov. 6, 2023.
(60) Provisional application No. 63/674,629, filed on Jul. 23, 2024.

(51) Int. Cl. G02B 6/46; G02B 6/44

(52) U.S. Cl. CPC G02B 6/475; G02B 6/4452; G02B 6/44528; G02B 6/4457; G02B 6/44715

(57) ABSTRACT

A fiber optic cable system and method are provided for high-density network installations. The system includes a trunk cable comprising at least 6912 optical fibers organized as twenty-four 288-fiber subunits. The subunits are routed through multiple breakout stages to connector modules housed in one or more rack-mountable panels. The system supports both preterminated and spliced end configurations, allowing modular deployment using MPO or VSFF connectors. A method of installation includes paying out the trunk cable from a reel, securing a preterminated panel at a second connection point, and splicing a blunt-cut end at a first connection point. A pulling system is also provided, comprising a pulling enclosure structured to retain a fiber panel and protect factory-terminated connectors during installation. The pulling enclosure incorporates a tensile sleeve and hoist grip to isolate axial load from the connectors during cable deployment.

### CROSS-REFERENCE TO RELATED APPLICATIONS

This Application claims the benefit of U.S. Provisional Application Ser. No. 63/674,629, filed Jul. 23, 2024; this Application is a Continuation-In-Part and claims the benefit of U.S. application Ser. No. 18/938,870, filed Nov. 6, 2024; U.S. application Ser. No. 18/938,870 claims the benefit of U.S. Provisional Application Ser. No. 63/596,560, filed Nov. 6, 2023. Each of the aforementioned applications is hereby incorporated by reference for all purposes.

### BACKGROUND

In modern data centers, the demand for high-capacity and reliable connectivity solutions has become increasingly critical. Data centers, especially in the case of hyperscale data centers, are required to support applications like artificial intelligence, machine learning, and associated massive data processing, all of which necessitate high-speed, low-latency communication. Traditionally, data centers have relied on fiber optic trunk cables to interconnect servers, storage, and networking equipment. These cables typically feature single or multifiber connectors that are manually installed at both ends, requiring careful handling when being pulled through cable conveyances to avoid damage to fiber connectors.

Current data center installations involve the manual pulling of fiber trunk cables through cable trays or ducts from one connection point to another. This process includes attaching a pulling sock to the fiber cable and pulling the cable through the tray, followed by unpacking and preparing the cable for connection.

With the ongoing expansion of data centers and the growing complexity of their infrastructure, the industry is searching for methods to streamline the fiber installation process while improving reliability and reducing labor requirements. The need for efficient, scalable solutions is becoming more urgent as the volume of fiber installations grows in line with demand for faster, higher-capacity networks.

The manual processes of installation, including cleaning, connecting, and assessing the cables, are time-consuming and prone to errors, leading to delays and potential rework. The manual steps introduce several challenges, including the risk of connector contamination, fiber damage, and connection errors. Furthermore, the use of pulling socks and additional protective materials generates waste and adds complexity to the process. These factors collectively contribute to higher labor costs, longer installation times, and increased risks of network downtime during the deployment phase.

### SUMMARY

In an illustrative embodiment, a fiber optic cable system includes a high-capacity trunk cable comprising at least 6912 optical fibers organized as twenty-four 288-fiber subunits. Each subunit branches into a sequence of breakout stages terminating in standardized connectors, such as MPO-12 or VSFF16, that interface with rack-mounted modules. The connector modules are integrated into a one rack unit fiber panel capable of supporting either 1152 fibers (via MPO connectors) or 3456 fibers (via VSFF connectors). One end of the trunk may be spliced in the field while the opposite end may be preterminated and factory-tested, enabling flexibility for hybrid deployment scenarios. The architecture supports mass fusion splicing, modular scalability, and compatibility with dense data center environments.

In another embodiment, a method of installation includes providing the trunk cable wound on a payout reel, positioning the reel at a first connection point, and deploying the trunk cable to a second connection point. The method further includes mounting a factory-preterminated fiber panel at the second point and splicing a blunt-cut end of the trunk at the first point. During payout, the panel co-rotates with the reel to maintain organized fiber routing. This process reduces on-site labor by allowing one end of the system to be fully assembled and evaluated in advance, while preserving flexibility at the splice end.

In yet another embodiment, a pulling system includes a pulling enclosure designed to protect a preterminated modules for fiber panel during installation. The enclosure is configured to house a set of connector modules, and is configured for transport through standard conduit dimensions. A hoist grip attaches to a tensile sleeve near the trunk cable's leading end, allowing pulling forces to be applied without damaging internal fibers or connector interfaces. This pulling configuration permits secure deployment of preterminated modules into the field while maintaining end-to-end optical integrity validated during factory testing.

Other aspects of the invention will be apparent from the following description and the appended claims.

### BRIEF DESCRIPTION OF DRAWINGS

FIG. 1 shows a payout system for pre-terminated datacenter trunk cables in accordance with one or more embodiments of the invention.

FIG. 2 shows a fiber panel in accordance with one or more embodiments of the invention.

FIG. 3 shows an assembly of linked containers in accordance with one or more embodiments of the invention.

FIGS. 4A and 4B show a pulling container in accordance with one or more embodiments of the invention.

FIG. 5 shows a cross-sectional view of a trunk cable, in accordance with one or more embodiments of the invention.

FIG. 6 shows a schematic breakout view of the trunk cable, in accordance with one or more embodiments of the invention.

FIG. 7 shows a method for installing trunk cables in a data center, in accordance with one or more embodiments of the invention.

Like elements in the various figures are denoted by like reference numerals for consistency.

### DETAILED DESCRIPTION

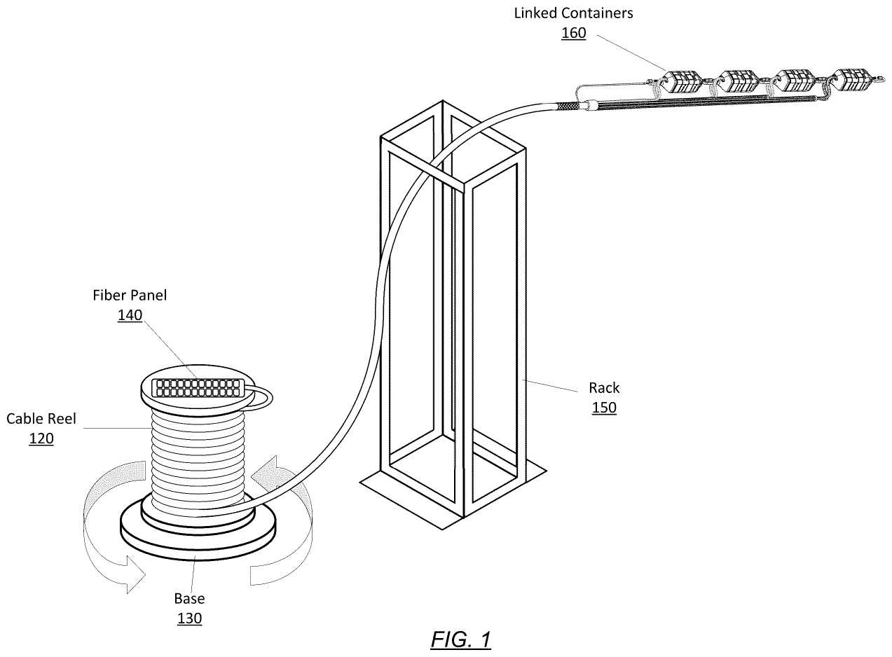

Turning to FIG. 1, a payout system for pre-terminated datacenter trunk cables is shown according to illustrative embodiments.

The trunk cable (110) is a high-capacity fiber optic cable that connects various data center components. The trunk cable provides the high-speed optical connections between network devices within the data center, ensuring low-latency data transmission. The trunk cable (110) typically contains multiple individual optical fibers, which may be housed within a protective sheath. The trunk cable may be made of silica glass, which is encased in several layers of protective materials, such as buffer tubes, strength members, and a polyethylene outer jacket.

The cable may be pre-terminated, meaning it comes with connectors already attached to both ends, eliminating the need for on-site termination. The trunk cable may be pre-terminated at both ends to eliminate the need for field termination, reducing potential errors and installation time.

The trunk cable (110) may be rotatably mounted on the cable reel (120). The cable reel (120) is a mechanical cylindrical component designed to hold and dispense the fiber trunk cable. The reel is designed to carry a pre-terminated fiber trunk cable, coiled around its circumference for storage. The cable reel is typically made from durable materials, such as steel, wood, or heavy-duty plastic, to support the weight of high fiber-count cables. As the reel spins, trunk cable stored on the reel is paid out for distribution through the data center.

The reel is mounted on a base (130), which supports its vertical positioning and rotational movement of the reel. Base (130) allows the reel to rotate during cable payout, and may include bearings or a swivel to facilitate rotation.

The fiber panel (140) serves as the interface for the pre-terminated fiber modules. The fiber panel contains multiple connector slots where the pre-terminated fibers are stored and organized. The fiber panel is removably mounted on top of the cable reel and in a position that allows seamless payout as the cable is deployed from the reel, simplifying the installation process. The fiber panel spins with the reel as the cable is paid out into the data center.

The fiber panel (140) is removably mounted on top of the cable reel and contains a plurality of the pre-terminated fiber modules that include standardized ports (such as LC, MPO, or VSFF (very small form factor) connectors), allowing for compatibility with common networking hardware. The panel may be pre-assembled with the fiber trunk cable and remains attached to the cable during the payout process, ensuring that the pre-terminated fibers are protected and organized. Upon payout completion, the fiber panel is transferred to the designated rack for connection.

The rack (150) is a vertical framework used to house and organize the networking equipment and cables within the data center. The rack is designed to support the fiber panel once the trunk cable has been fully deployed. The rack is typically made from materials like steel or aluminum and is designed to hold a large amount of weight while remaining stable.

The rack dimensions are sized to accommodate different panels having with different form factors, such as 1U, 2U, or larger units, where “U” represents a standard rack unit of measure equal to 1.75 inches in height. The outer dimensions of rack (150) align with the widths of most network and server equipment. For example, rack width (104) may measure 19 inches (48.26 cm) or 23 inches (58.42 cm) in width, standard measurements that are adhered to in the telecommunications industry. Other dimensions may be used, e.g., 21 inches, 23 inches, etc.

The rack (150) may include a series of uniformly spaced vertical mounting slots, located on both the front and rear, which serve as attachment points for mounting panel(s) associated with telecommunication equipment. The mounting slots and brackets are compatible with data center equipment, having standardized spacing between the slots of the rack (150) ensuring that the fiber panel can be securely fastened.

Each mounting slot of the rack (150) may be equipped with fastening mechanisms, enabling the fixation of mounting brackets and panels in a secure and stable manner. The utilization of these mechanisms ensures that the mounted equipment remains firmly in place, even during transportation or in environments with vibrations.

The rack (150) may further be equipped with ventilation openings strategically positioned on the front and rear of the rack (150). The ventilation openings promote adequate airflow within the rack, preventing the accumulation of heat and ensuring optimal operating conditions for the housed telecommunication equipment. Ventilation may contribute to the overall longevity and reliability of the installed devices.

The rack (150) may be designed to facilitate cable management. The rack (150) may incorporate integrated cable routing features, such as cable tie points and channels, which enable the organized routing and bundling of cables connected to the telecommunication equipment. The cable management provided by the rack (100) may enhance the aesthetic design of the rack (150) and simplify maintenance tasks by providing clear pathways for troubleshooting and repairs.

The linked containers (160) are modular enclosures that house one or more pre-terminated fiber modules during payout. The containers (160) are linked together via a flexible linkage, which allows the containers to move through bends and curves in the data center's cable trays or ducts. Multiple containers are connected in series to form a continuous chain, allowing multiple fiber modules to be pulled simultaneously during installation.

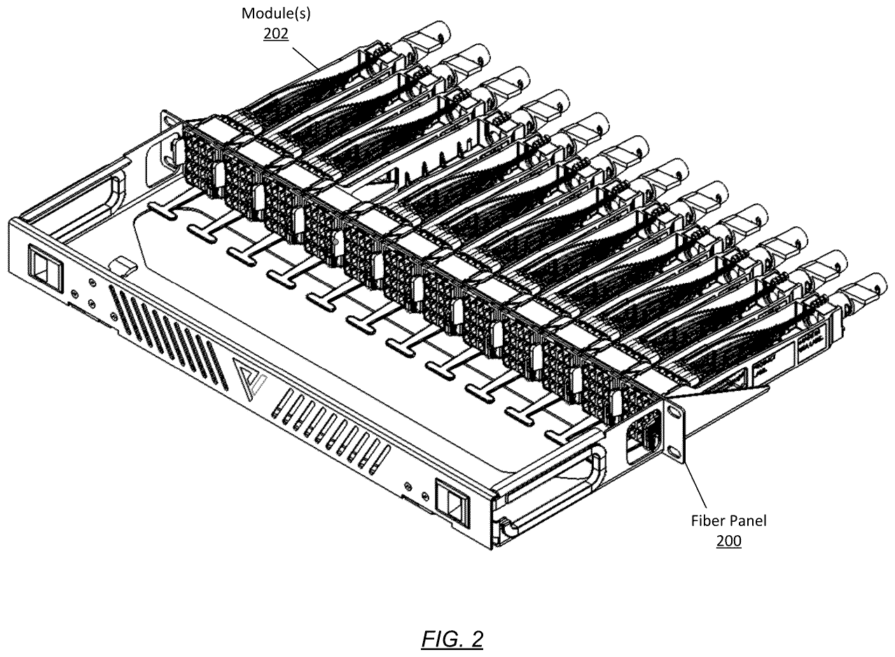

Turning to FIG. 2, a fiber panel is shown according to illustrative embodiments. The panel 200 is an example of fiber panel (140) of FIG. 1.

the panel (200) includes the modules (202). The modules (202) are front-loading modules. The modules, of a similar form factor, may also be rear loading. In one embodiment, the panel (200) may be configured to fit a 19-inch rack. In one embodiment, the panel (200) has a 1U panel height of about 1.75 inches (44.45 millimeters) and a width of about 19 inches (482.6 millimeters). In one embodiment, the panel (200) includes spaces for 12 of the modules (202). Each of the modules (202) includes multiple optical fiber couplers.

In one embodiment, each module (202) includes 16 LC (Lucent connector) couplers, and the panel (200) includes 192 optical couplers for a 19-inch rack. Additional modules and couplers may be included in panels for larger racks. For example, a panel for a 23-inch rack may include space for 14 modules and 224 couplers. Diverse types of couplers and connectors may be used in addition to LC couplers, including MPO (multi fiber push on) connectors, MTP (multi-fiber termination push-on) couplers, VSFF (very small form factor) connectors, etc.

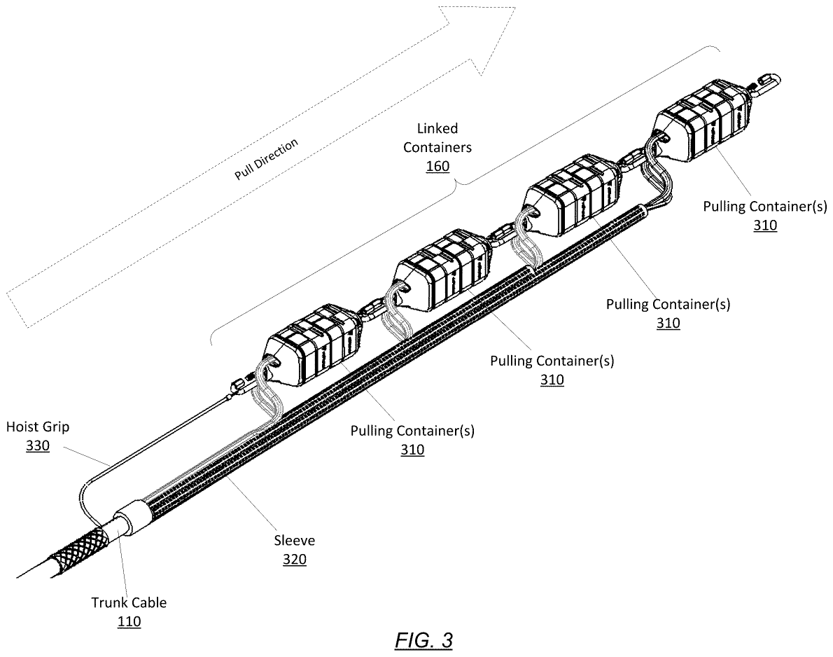

Referring to FIG. 3, the assembly of linked containers (160) includes the trunk cable (110). the trunk cable (110) includes cables that connect to modules housed within one or more pulling container(s) (310). The cables route from modules in the pulling container(s) (310), through exit holes to the trunk cable (110).

The pulling container(s) (310) are enclosures designed to protect fiber modules during the pulling process. These containers are typically constructed from durable materials, such as reinforced plastic or metal, to prevent damage to the fiber connectors during installation. Each pulling container features attachment points that allow them to be connected in series, ensuring that the entire length of the fiber trunk cable can be pulled as a single unit. These containers may also include padding or shock-absorbing features to further protect the internal components from impact or vibration.

In an embodiment, each of the pulling container(s) (310) may be loaded with twelve modules. The twelve modules for one of the pulling container(s) (310) may fill a panel. The panels, filled by the modules of the four-pulling container(s) (310), may fill three slots of a rack in a server cabinet. Other sizes of the pulling container are offered which, when full, support one, four, six, and other quantities of modules.

Multiple pulling container(s) (310) may be linked together using a linkage, such as a carabiner connected to a rear eyelet of the pulling container(s) (310). The linkage may connect between the pulling container(s) (310), as well as the hoist grip (330) to form the linked containers (160).

The hoist grip (330) may be secured at the leading edge of the assembly, and transmits the pulling force along the length of the trunk cable and linked containers. The hoist grip (330) acts as a tension member, such as a rope, which connects to the trunk cable to transfer tension to the insulation of the trunk cable (110) without damaging the fibers or connectors housed within the linked containers. A sleeve (320) may locate proximal to the hoist grip to reinforce the trunk cable at adjacent to the hoist grip and distributes the tensile load.

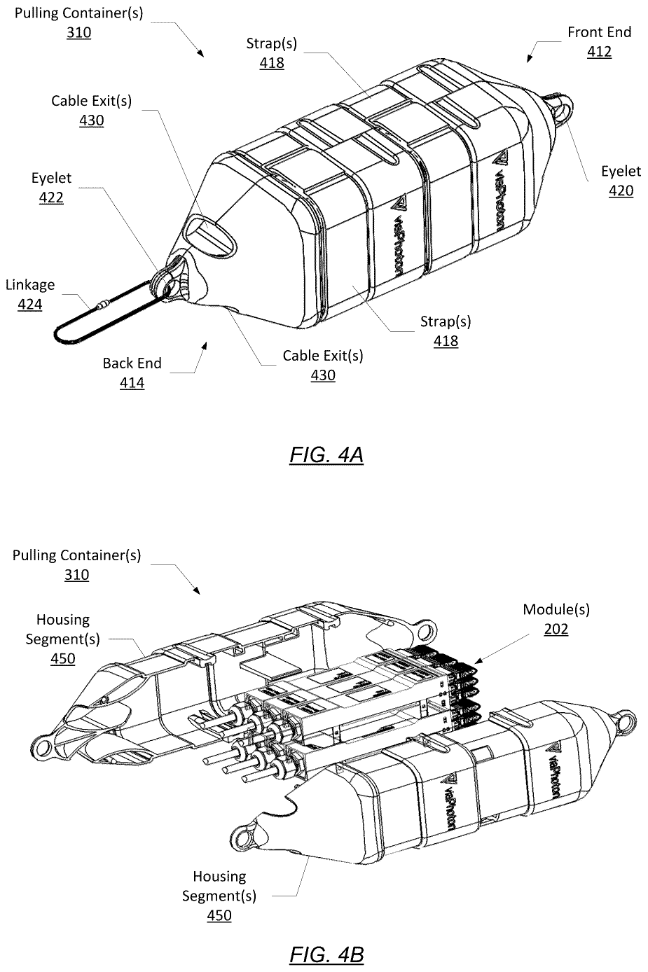

Turning to FIG. 4A, the pulling container (310) is illustrated. The pulling container (310) includes the front eyelet (420), the tapered front end (412), the tapered back end (414), the cable exit(s) (430), the rear eyelet (422), and the linkage (424).

The front eyelet (420) may also be referred to as a front pulling eye. The front eyelet (420) provides an attachment point for the pulling container (310) to be pulled from one location to another by attaching a rope (or similar pulling method). The front eyelet (420) may also be used to connect additional containers to each other in succession by attaching the linkage (424) (e.g., a carabiner or similar attachment mechanism) to a rear eyelet of a container in front of the pulling container (310). Multiple containers may be connected together and pulled in succession.

The tapered front end (412) and the tapered back end (414) are angled surfaces. The tapered front end (412) and the tapered back end (414) reduce the chance of the pulling container (310) getting snagged on obstructions as the pulling container (310) moves through cable pathways and around obstacles.

The cable exit(s) (430) allow cables to exit the pulling container (310). The cable exit(s) (430) are positioned on two sides of the rear eyelet (422), which may be opposite sides, e.g., an upper side and a lower side.

Straps (418) (e.g., a hook-and-loop strap or similar strapping device) may be installed around the periphery of the pulling container (310). In some embodiments, the straps may be positioned into a recess in the housing so that the straps (418) do not fall off or get caught or snagged on obstructions during pulling.

Referring now to FIG. 4B, the pulling container(s) (310) is illustrated in an exploded view. the pulling container(s) (310) forms an outer shell and may be composed of multiple housing segments (450), i.e., two halves, which come together to form an enclosure to contain and protect multiple modules (202). When assembled, the pulling container(s) (310) encloses a bundle of modules(s) (202) between the housing segment(s) (450). The bundle of the modules(s) (202) may be arranged in two rows with three modules per each row.

In an embodiment, the multiple housing segments (450) may be structurally the same and made with the same tooling. In other words, each housing segment(s) (450) may be identical to each other.

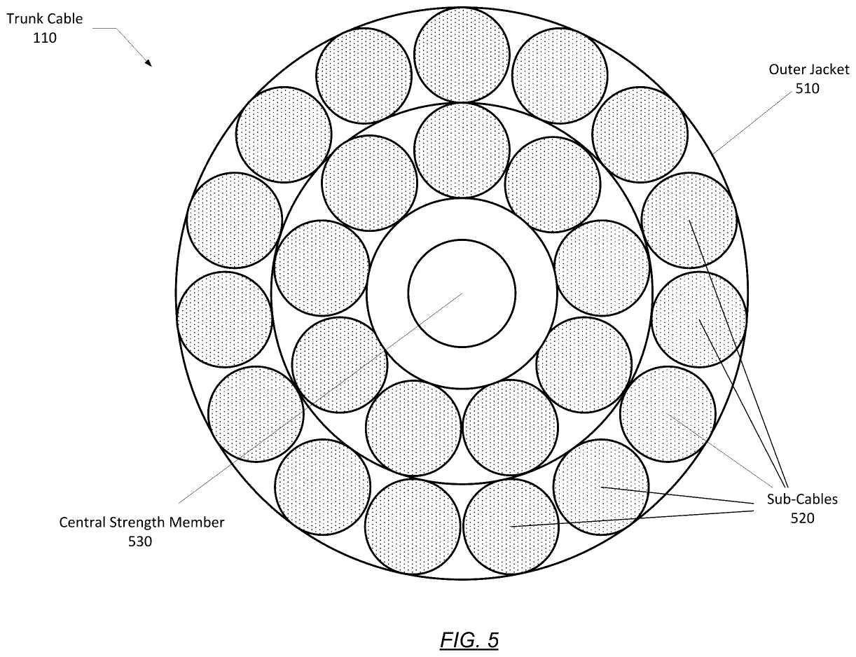

FIG. 5 shows a cross-sectional view of a trunk cable (110) in accordance with one or more embodiments. The trunk cable includes an outer jacket (510), a central strength member (530), and a plurality of sub-cables (520) positioned circumferentially around the central strength member.

The outer jacket (510) defines the outermost radial boundary of the trunk cable (110). It provides mechanical protection, environmental sealing, and structural containment for the sub-cables. The outer jacket (510) may be constructed from polyethylene, thermoplastic, or another sheath material capable of protecting internal fiber structures from moisture, abrasion, and compression forces during deployment and operation.

The sub-cables (520) are arranged radially and concentrically around the central strength member (530). Each sub-cable (520) represents an optical fiber-containing unit, such as a 288-fiber subunit in a 6912-fiber system configuration. The sub-cables may include internal ribbonized fiber groupings composed of 12-fiber ribbons, allowing for high-density packing and compatibility with mass fusion splicing equipment. Each sub-cable (520) may further comprise its own buffer tube, water-blocking elements, and strength yarns.

The central strength member (530) is axially positioned at the center of the cable structure and acts as a tensile backbone for the trunk cable (110). It may be formed of fiberglass-reinforced plastic, steel, or another material with sufficient tensile strength and thermal stability to prevent axial elongation or compression of the trunk cable under mechanical stress. The central strength member also serves to maintain the shape and geometry of the sub-cable arrangement during bending and handling.

The arrangement of sub-cables (520) around the central strength member (530) enables the cable to maintain a balanced mechanical structure, minimizing cross-sectional deformation during reel payout or conduit pulling. The consistent radial spacing of the sub-cables also ensures even tensile load distribution when the cable is under strain.

In one embodiment, the trunk cable (110) comprises twenty-four sub-cables (520), each containing 288 optical fibers, for a total of 6912 optical fibers. The structure supports modular breakout and splicing at intermediate stages in the deployment process, consistent with the system and method claims describing a multi-stage preterminated fiber architecture. The sub-cables are isolated from one another within the outer jacket (510), facilitating identification, routing, and termination during installation and operation.

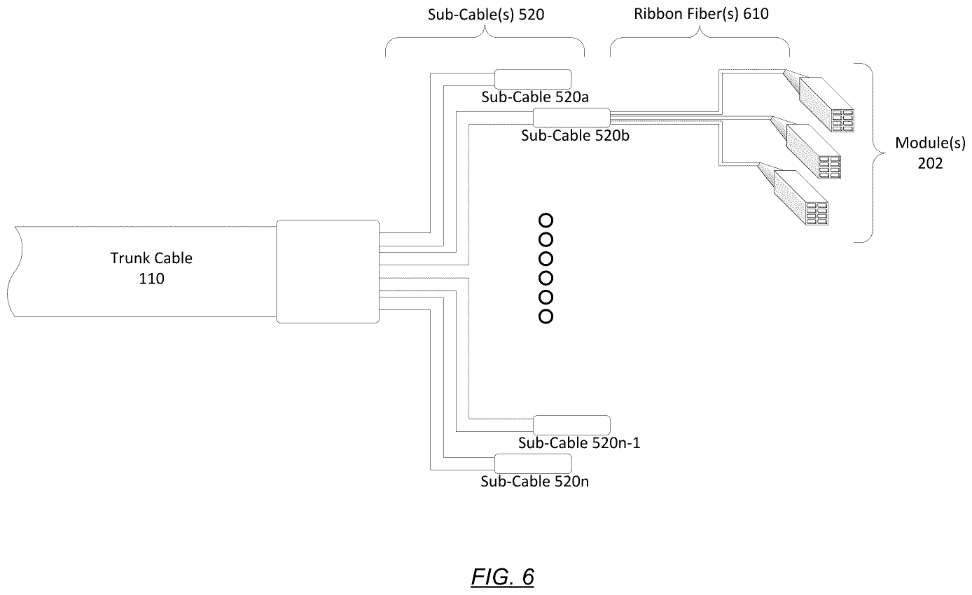

FIG. 6 illustrates a breakout schematic of a trunk cable (110) according to one or more embodiments. The diagram shows the relationship between the trunk cable, a plurality of sub-cables (520), internal ribbon fiber structures (610), and downstream termination modules (202).

The trunk cable (110) includes a set of sub-cables (520), individually labeled in the figure as sub-cable 520a, sub-cable 520b, sub-cable 520ₙ₋₁, and sub-cable 520ₙ, where “n” represents the total number of sub-cables within the trunk cable. Each sub-cable (520) is routed from the interior of the trunk cable and carries a bundle of optical fibers. In one embodiment, the sub-cables are 288-fiber units corresponding to 24 ribbon fibers per sub-cable.

Each sub-cable (520) contains a plurality of ribbon fibers (610), which extend from the sub-cable and are directed to a corresponding module (202). The ribbon fibers (610) are organized structures that align multiple individual optical fibers in a planar array, typically twelve fibers per ribbon. These ribbon fibers are suitable for mass fusion splicing and for termination with high-density connectors such as MPO-12 or VSFF16.

The modules (202) receive the ribbon fibers (610) and terminate them to provide a standardized interface for connectivity. Each module (202) may include a plurality of optical couplers or adapters for fiber optic connectors. The modules may be mounted within a fiber panel at either end of the trunk cable, depending on the configuration. In some embodiments, the modules are part of a preterminated panel assembly; in others, the modules are connected via field splicing.

The illustrated breakout arrangement supports the multi-stage breakout architecture referenced in the claims, where each sub-cable represents a high-capacity unit that is further subdivided into ribbonized segments for structured termination. The ability to route and terminate sub-cables individually enables modular scalability and compatibility with data center architectures requiring either blunt-cut splicing or factory-terminated connectivity.

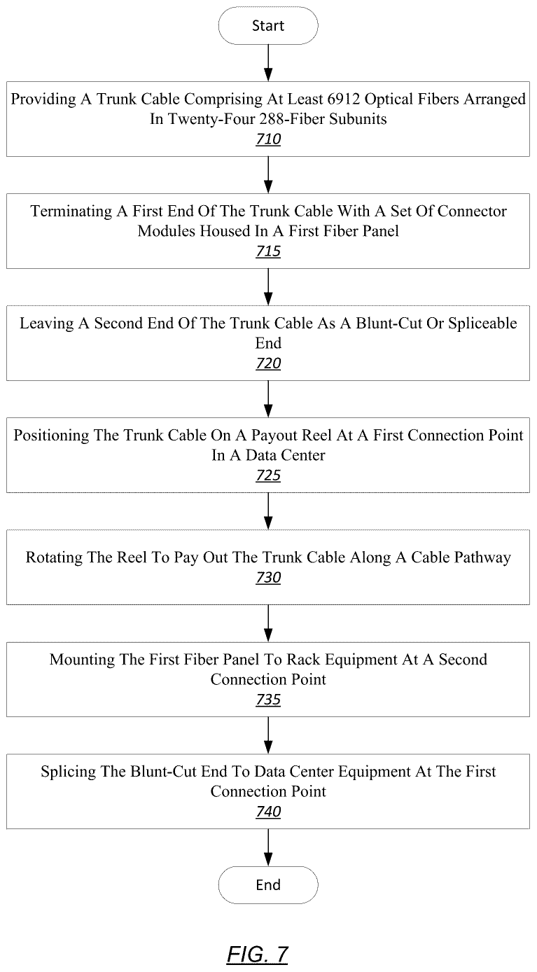

Turning now to FIG. 7, a method for installing trunk cables in a data center is shown in accordance with one or more embodiments of the invention.

At block 710, a trunk cable is provided comprising at least 6912 optical fibers. These fibers are organized into twenty-four 288-fiber subunits. Each subunit may be formed using ribbonized fiber structures. The cable structure includes an outer protective jacket and a central strength member. This trunk cable supports high-fiber-count deployments and is configured for modular termination and splicing.

At block 715, the first end of the trunk cable is terminated with a set of connector modules to be housed in a first fiber panel. The modules may use MPO-12 or VSFF16 connectors and are arranged within a one rack unit form factor. This fiber panel is factory-preterminated and optically evaluated before installation. The terminated modules provide a standardized interface for connection to data center equipment at the second connection point.

At block 720, a second end of the trunk cable is left as a blunt-cut or spliceable end. The sub-cables at this end are stripped of the outer jacket to expose individual ribbons for field splicing. This configuration allows the installer to fuse the exposed fibers to corresponding infrastructure fibers at the first connection point using mass fusion splicing techniques.

At block of 725, the trunk cable is positioned on a payout reel at a first connection point in a data center. The reel is mounted to allow free rotation and controlled payout. The payout reel may also hold the fiber panel associated with the terminated end, and the reel is placed near the location where the blunt-cut end will be spliced.

At block 730, the reel is rotated to pay out the trunk cable along a defined cable pathway. The cable is routed through conduits or trays leading from the first connection point to the second. During payout, the preterminated fiber panel may rotate with the reel to maintain cable alignment and prevent torsional stress on the internal sub-cables.

At block 735, the first fiber panel is mounted to a rack equipment at the second connection point. The panel is secured in a rack and connected to local patch cables or equipment ports. This step completes the physical installation of the preterminated end of the trunk.

At block 740, the blunt-cut end of the trunk cable is spliced to data center equipment at the first connection point. Ribbon fibers exposed from each sub-cable are aligned and fused to matching ribbon fibers in the local infrastructure. The splices are housed in a splice tray or enclosure, completing the optical pathway between both ends of the trunk cable.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A fiber optic cable system, comprising:
a trunk cable comprising at least 6912 optical fibers organized as twenty-four 288-fiber subunits;
a first breakout stage comprising a set of 288-fiber legs extending from respective subunits of the trunk cable;
a second breakout stage comprising a set of 96-fiber legs each terminated by a first connector module;
a third breakout stage comprising a set of MPO-12 connectors connected to respective fibers from at least one of the 96-fiber legs;
a first fiber panel including a set of preterminated connector modules connected to the third breakout stage and preloaded in a one rack unit panel; and
a second fiber panel connected to a blunt-cut or spliced end of the trunk cable.

2. The system of claim 1, wherein the trunk cable comprises a construction with 200 μm bend-insensitive single-mode fiber.

3. The system of claim 1, wherein the first fiber panel comprises a plurality of modules each comprising eight MPO-12 connectors, and each panel supports 96 fibers per module for a total of 1152 fibers per panel.

4. The system of claim 1, wherein the first fiber panel comprises a plurality of modules each comprising eighteen VSFF16 connectors, and each panel supports 288 fibers per module for a total of 3456 fibers per panel.

5. The system of claim 1, wherein each of the 288-fiber subunits comprises twenty-four 12-fiber ribbons.

6. The system of claim 1, wherein the trunk cable comprises twenty-four 288-fiber subunits arranged within a central strength member and water-blocked outer jacket.

7. The system of claim 1, wherein the second fiber panel comprises a splice panel located at a first connection point.

8. The system of claim 1, wherein the first fiber panel is installed at a second connection point and preterminated in a factory prior to installation.

9. The system of claim 1, further comprising a pulling enclosure containing the first fiber panel, wherein the pulling enclosure is sized to fit within a conduit having a diameter of six inches.

10. The system of claim 1, wherein optical continuity from the first fiber panel to the second fiber panel is factory verified before shipment.

11. A method of installing a fiber optic cable system, comprising:
providing a trunk cable comprising at least 6912 optical fibers arranged in twenty-four 288-fiber subunits;
terminating a first end of the trunk cable with a set of connector modules housed in a first fiber panel;
leaving a second end of the trunk cable as a blunt-cut or spliceable end;
positioning the trunk cable on a payout reel at a first connection point in a data center;
rotating the reel to pay out the trunk cable along a cable pathway;
mounting the first fiber panel to rack equipment at a second connection point; and
splicing the blunt-cut end to data center equipment at the first connection point.

12. The method of claim 11, further comprising testing optical continuity between the connector modules of the first fiber panel and the fibers of the trunk cable before deployment.

13. The method of claim 11, wherein the first fiber panel comprises preterminated modules with MPO-12 or VSFF16 connectors.

14. The method of claim 11, further comprising housing the first fiber panel in a pulling enclosure during cable installation.

15. The method of claim 11, wherein the trunk cable comprises a cable having 200 μm bend-insensitive fibers and a dry water-blocked core.

16. A pulling system for installing a preterminated fiber optic cable, comprising:
a pulling enclosure structured to house a set of preterminated connector modules;
a trunk cable comprising a plurality of optical fibers connected to the connector modules within the enclosure;
a hoist grip affixed to a leading portion of the trunk cable; and
a tensile sleeve located between the hoist grip and the pulling enclosure to transfer axial force while isolating the connectors from tensile stress.

17. The system of claim 16, wherein the pulling enclosure has a form factor suitable for passage through a six-inch diameter conduit.

18. The system of claim 16, wherein the pulling enclosure includes internal support members to retain the fiber panel and manage fiber bend radius.

19. The system of claim 16, wherein the pulling enclosure is removably secured to the payout reel for transport and payout.

20. The system of claim 16, wherein the connector modules in the fiber panel comprise MPO-12 connectors, VSFF16 connectors, or a combination thereof.
